(19) United States
(12) Patent Application Publication
(10) Pub. No.: US 2008/0293752 A1
(43) Pub. Date: Nov. 27, 2008

(54) Antiseptic body glide

(76) Inventor: Ronald W. Ziemann, Albuquerque, NM (US)

Correspondence Address: ORTIZ & LOPEZ, PLLC, P.O. BOX 4484, ALBUQUERQUE, NM, 87196-4484, US

(21) Appl. No.: 11/805,386

(22) Filed: May 22, 2007

(51) Int. Cl. A01N 43/34; A01N 37/52; A01P 1/00

(52) U.S. Cl. 514/277; 514/636

(57) ABSTRACT

An antiseptic body glide is a body glide with antiseptic properties. The antiseptic components do not interfere with other body glide components such as lubricants or preservatives. Additionally, the antiseptic body glide does not react unfavorably with latex. The antiseptic components do not have a bad taste or react with the other components to produce a bad taste. As such, the antiseptic body glide enhances intimate activities without compromising those activities in any way.

### TECHNICAL FIELD

Embodiments relate to body glides and personal lubricants. Embodiments also relate to antiseptics and in particular to flavorful antiseptic personal lubricants and body glides.

### BACKGROUND OF THE INVENTION

Body glides and personal lubricants, referred to herein simply as glides, are specialized lubricants designed for reducing friction during intimate acts. Glides should provide an appropriate level of viscosity without also causing irritation, stains, or unpleasant odors.

Current technology provides water based glides and oil based glides. Oil based glides produce an oily film that is not water soluble and can be difficult to remove. As such, oil based glides are generally considered inappropriate for penetrative sex because they can remain in situ for considerable time and provide a welcoming environment for bacteria and other infectious organisms.

Water based glides provide viscosity but can dry out, be absorbed, or wash away. Normally, washing away is a good thing except in hot tubs, spas, pools, waterfalls, and other aquatic environments where many water based glides, including the body's natural lubrication, prematurely wash away. Some glides contain a silicone component that can maintain viscosity in aquatic settings.

Astroglide is a personal lubricant containing water, glycerin, and propylene glycol as lubricants. Astroglide contains polyquaternium 15, methylparaben, and propylparaben as preservatives. Biofilm, Inc, the manufacturer of Astroglide, claims to use a special formulation, discovered in 1977 in support of the space shuttle program that keeps Astroglide from getting as thick and gummy. A body glide marketed as “Wet” contains water, glycerin, carbomer, PEG, propylene glycol, hydroxyethylcellulose, methylparaben, aloe vera, citric acid, and other compounds.

In the United States (US), personal lubricants are regulated by the Food and Drug Administration (FDA) and must meet certain health and safety requirements while being manufactured in conformance with federal regulations. Current products meet the FDA regulations.

Although the current art does provide a number of glides, systems and methods to provide antiseptic properties without compromising other desirable properties or violating FDA regulations are needed.

### BRIEF SUMMARY

The following summary is provided to facilitate an understanding of some of the innovative features unique to the embodiments and is not intended to be a full description. A full appreciation of the various aspects of the embodiments can be gained by taking the entire specification, claims, drawings, and abstract as a whole.

It is therefore an aspect of the embodiments that a body glide comprises a preservation component, lubrication component, and an antiseptic component.

The main purpose of a body glide is to lubricate. Glycerin and propylene glycol work well as body glide lubricants. Water, while not itself a good body glide lubricant, can enhance the lubrication effects of other components, particularly glycerin.

A body glide should contain a preservative to prolong shelf life. Parabens are a class of preservatives including methylparaben, ethylparaben, propylparaben, and butylparaben. Methylparaben and polyparaben work very well as body glide preservative. Polyquaternium 15 also has some preservative properties and works well in body glides.

Body glides do not need to contain antiseptic components, but antiseptics do kill micro organisms and can thereby help prevent the spread of some human pathogens. Chlorhexidine glucanate and cetylpyridinium chloride are antiseptics that can be included in body glides without comprising lubrication or shelf life.

### BRIEF DESCRIPTION OF THE DRAWINGS

The accompanying figures, in which like reference numerals refer to identical or functionally similar elements throughout the separate views and which are incorporated in and form a part of the specification, further illustrate aspects of the embodiments and, together with the background, brief summary, and detailed description serve to explain the principles of the embodiments.

FIG. 1 illustrates components of an antiseptic body glide in accordance with aspects of the embodiments;

FIG. 2 illustrates classifications of certain preservatives in accordance with aspects of the embodiments;

FIG. 3 illustrates a couple antiseptics in accordance with aspects of the embodiments;

FIG. 4 illustrates a couple lubricants in accordance with aspects of the embodiments; and

FIG. 5 illustrates shot packaging in accordance with aspects of the embodiments.

### DETAILED DESCRIPTION

The particular values and configurations discussed in these non-limiting examples can be varied and are cited merely to illustrate at least one embodiment and are not intended to limit the scope thereof. In general, the figures are not to scale.

An antiseptic body glide is a body glide with antiseptic properties. The antiseptic components do not interfere with other body glide components such as lubricants or preservatives. Additionally, the antiseptic body glide does not react unfavorably with latex or other common barrier materials. The antiseptic components do not have a bad taste or react with the other components to produce a bad taste. As such, the antiseptic body glide enhances intimate activities without compromising those activities in any way.

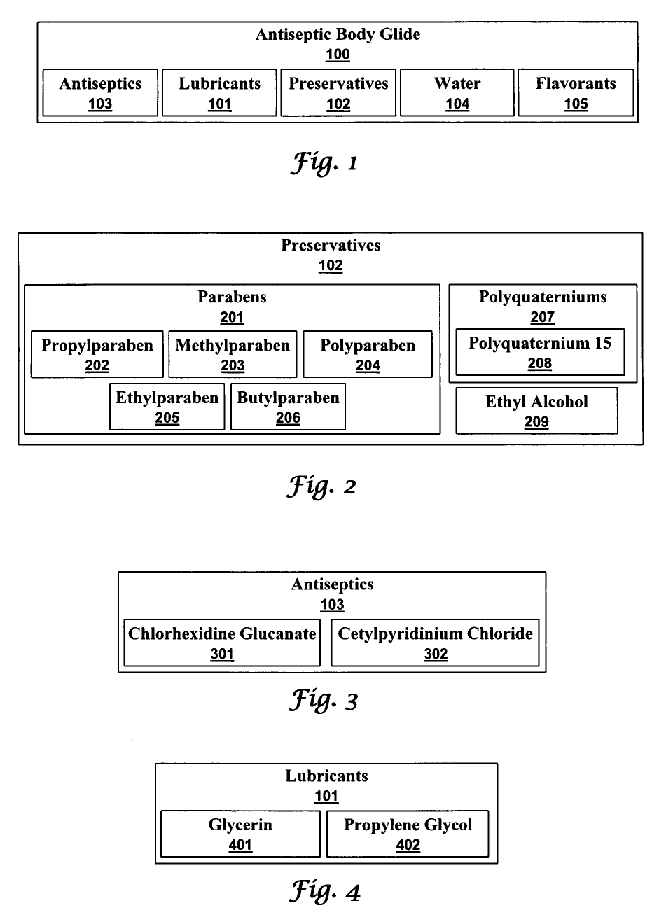

FIG. 1 illustrates components of an antiseptic body glide 100 in accordance with aspects of the embodiments. The antiseptic body glide can contain antiseptics 103, lubricants 101, preservatives 102, water 104, and flavorants 105.

FIG. 2 illustrates classifications of certain preservatives 102 in accordance with aspects of the embodiments. Parabens 201, polyquaterniums 207, and ethyl alcohol 209 are three types of preservatives 102 that can help increase the shelf life of antiseptic body glides. Parabens 201 are exemplified by methylparaben 203, ethylparaben 205, propylparaben 202, butylparaben 206, and polyparaben 204. Methylparaben 203 and polyparaben 204 have proven to be good choices for antiseptic body glides because they do not react unfavorably with other body glide components while also retaining their preservative properties.

FIG. 3 illustrates a couple of antiseptics 103 in accordance with aspects of the embodiments. There are many different types of antiseptics available, but few of them are appropriate for an antiseptic body glide because they smell, taste bad, react with other components, or irritate the skin. Particularly important properties of appropriate antiseptics is that they are edible and do not irritate the sensitive skin and membranes in body cavities. Tests of chlorhexidine glucanate 301 and cetylpyridinium chloride 302 have shown them to have the proper characteristics for use as antiseptics in body glides.

FIG. 4 illustrates a couple lubricants 101 in accordance with aspects of the embodiments. Glycerin 401 and propylene glycol 402 work well as components of personal lubricants and body glides. Other components, such as antiseptics and preservatives, should not compromise the properties of glycerin 401 or propylene glycol 402.

Flavorants are substances that confer a flavor. Body glide flavorants confer a flavor to body glides while also not compromising the other body glide components. For example, lye is not a body glide flavorant because it destroys other components and irritates the skin. Table 1 lists flavorants that can be used in a body glide.

Body Glide Flavorants

| Flavorant | Flavor |
|---|---|
| Diacetyl | Buttery |
| Isoamyl acetate | Banana |
| Cinnamic aldehyde | Cinnamon |
| Ethyl propionate | Fruity |
| Limonene | Orange |
| Octyl Acetate | Orange |
| Ethyl-(E, Z)-2,4-decadienoate | Pear |
| Allyl hexanoate | Pineapple |
| Ethyl maltol | Sugar, Cotton candy |
| Methyl salicylate | Wintergreen |
| Benzaldehyde | Bitter almond |
| Methyl Anthranilate | Grape |
| Geranyl Butyrate | Cherry |

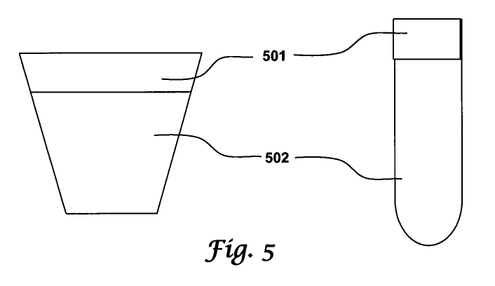

FIG. 5 illustrates shot packaging in accordance with aspects of the embodiments. A shot container 501 can contain a flavored body glide 502. Generally, a shot is about 1 ounce of liquid. Ethyl alcohol, discussed previously as a preservative because of its bactericide and bacteriostatic properties, also imparts flavor and can transform an antiseptic body glide into a libation. Clearly, all of the components of such a body glide must be safe for human consumption.

It will be appreciated that variations of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

The embodiments of the invention in which an exclusive property or right is claimed are defined as follows. Having thus described the invention what is claimed is:

1. An antiseptic body glide comprising:
at least one paraben;
a lubricant;
water; and
chlorhexidine glucanate.

2. The antiseptic body glide of claim 1 further comprising polyquaternium 15.

3. The antiseptic body glide of claim 1 wherein the lubricant comprises glycerin.

4. The antiseptic body glide of claim 1 wherein the lubricant comprises propylene glycol.

5. The antiseptic body glide of claim 1 further comprising ethyl alcohol.

6. The antiseptic body glide of claim 1 wherein the at least one paraben comprises methylparaben.

7. The antiseptic body glide of claim 1 wherein the at least one paraben comprises polyparaben.

8. The antiseptic body glide of claim 1 further comprising a flavorant.

9. The antiseptic body glide of claim 1 wherein the body glide is packaged as shots.

10. An antiseptic body glide comprising:
a paraben;
a lubricant;
water;
chlorhexidine glucanate; and
cetylpyridinium chloride.

11. The antiseptic body glide of claim 10 further comprising polyquaternium 15.

12. The antiseptic body glide of claim 10 wherein the lubricant comprises propylene glycol.

13. The antiseptic body glide of claim 10 further comprising ethyl alcohol.

14. The antiseptic body glide of claim 10 wherein the at least one paraben comprises methylparaben.

15. The antiseptic body glide of claim 10 wherein the at least one paraben comprises polyparaben.

16. The antiseptic body glide of claim 10 further comprising a natural flavorant.

17. The antiseptic body glide of claim 10 further comprising:
polyquaternium 15, ethyl alcohol, and an artificial flavorant;
wherein the carrier comprises glycerin and propylene glycol;
wherein the at least one paraben comprises methylparaben and polyparaben;

18. The antiseptic body glide of claim 1 wherein the body glide is packaged as a shot.

19. A method comprising:
obtaining a non-antiseptic lubricant comprising at least one paraben, glycerin, and propylene glycol;
obtaining an antiseptic comprising chlorhexidine glucanate;
combining the non-antiseptic lubricant and the antiseptic to produce an antiseptic body glide.
